(19) United States
(12) Patent Application Publication
(10) Pub. No.: US 2020/0027372 A1
(43) Pub. Date: Jan. 23, 2020

(54) MATHEMATICAL LEARNING RODS

(71) Applicant: Creative Design Ideas Limited, Cirencester (GB)

(72) Inventors: Richard Keith Hardstaff, Cirencester (GB); Andrew Haslam, Cirencester (GB)

(21) Appl. No.: 16/038,347

(22) Filed: Jul. 18, 2018

(51) Int. Cl. G09B 23/02; B29C 47/00

(52) U.S. Cl. CPC G09B 23/02; B29L 2031/5209; B29C 47/0066; B29C 47/0023

(57) ABSTRACT

A method of manufacturing a learning rod educational toy set comprising a plurality of hollow rod elements, each rod element having an indication of its length on an outer surface thereof, such as by a number or a symbol indicating total length in increments, such as inches or centimetres, each rod element being releasably connectable to another such rod element by a respective coupling element, the coupling element including a flanged region having an outer perimeter contiguous with the outer perimeter of the or each rod section, the method including the steps of, in any convenient order, extruding or otherwise forming a continuous tube of sectional shape corresponding to the required sectional shape of the rod elements, cutting the continuous tube into discrete lengths corresponding to chosen increments, such as inches or centimetres, providing an indication of the length of each rod element on an externally visible surface thereof, forming flanged coupling elements, each for insertion into an end of a respective rod element tube for connecting selected pairs of rod elements end-on-end to form a continuous rod, the flange of each coupling element being of a colour visibly distinct from the colour of the rod elements, thereby to provide a visible indication of the number of rod elements in a learning rod formed therewith. The invention also extends to a learning rod set made in accordance with the method.

### BACKGROUND OF THE INVENTION

This invention relates to learning rods of the type pioneered by Georges Cuisenaire ® during the middle of the last century in order to teach mathematical concepts such as arithmetic through the use of sets of differently sized and coloured rod elements, each colour corresponding to a particular length of rod element.

The original Cuisenaire rod elements were made from wood, each set comprising ten rod elements, each of different colour to other rod elements in the set, with the length of each rod element being an integer of a chosen linear measurement scale, such as the centimetric scale, the smallest rod element in the set having a length of 1 cm and the longest rod element having a length of 10 cm. This concept proved very useful as a means of teaching students the relationship between length and number, with each length of rod element being of a particular colour, usually also bearing a number or other sign indicating its length. These rod elements could be arranged in a linear fashion i.e. end-on-end so that the students were able to easily determine in numerical terms the entire length of a rod formed from a plurality of joined-up rod elements. However, a disadvantage of this system was that they could not be physically joined together to form an elongate rod which could be handled by the students and therefore required placement on a flat stable surface such as a desktop.

With the introduction of interlocking toys such as Lego ® this problem was resolved such that current learning rod elements supplied by Cuiseneaire ® and others are made from injection-moulded plastics in which each rod element comprises a tube of square section having a closed end from which extends a cylindrical connecting pip of diameter corresponding to the smallest of the inside diameter of the tube, the open end of which acts as a socket for the connecting pip of another such rod element so that any number of rod elements can be connected together via a push fit to form a single elongate learning rod of length equal to the sum of its constituent parts. However, as will be apparent, the manufacture of each respective size of rod element requires a respective injection moulding tool such that where ten such rod elements are required, each of a different length to the other rod elements in the set, a total of ten moulds are required, which is expensive. Similarly, for each of the ten such rod elements a separate colour of plastic is usually required in order to easily distinguish rod elements of different lengths. Although the separate colour concept may be dispensed with as a means of reducing the complexity and cost of manufacture, the difficulty then arises that if the rod elements are of the same colour but of differing lengths it is not easy to visually distinguish the point where one rod element joins with another and therefore the point where a rod element having one number value has been added to by another rod element having another number value such that the overall length can be attributed to the sum of the number values.

The present invention is derived from the realisation that there is a need for a less complicated and less expensive way of manufacturing learning rods of the Cuisenaire type in plastics whilst retaining visual simplicity whereby students can readily construct and handle learning rods assembled from multiple rod elements joined end-on-end in which the overall length is easily identifiable.

### SUMMARY OF THE INVENTION

According to a first aspect of the invention there is provided a method of manufacturing a learning rod educational toy set comprising a plurality of rod elements, each rod element having an indication of its length on an outer surface thereof, such as by a number and/or a symbol indicating total length in increments, such as inches or centimetres, each rod element being releasably connectable to another such rod element by a respective coupling element, the coupling element including a flanged region having an outer perimeter generally contiguous with the outer perimeter of the or each rod element, the method including the steps of, in any convenient order, extruding a continuous tube or other elongate extrusion of sectional shape corresponding to the required sectional shape of the rod elements, cutting the continuous extrusion into discrete lengths corresponding to chosen increments, such as inches or centimetres, providing an indication of the length of each rod element on an external surface thereof, forming flanged coupling elements, each for attachment to an end of a respective rod element for connecting selected pairs of rod elements end-on-end to form a continuous learning rod, the flange of each coupling element being of a colour visibly distinct from the colour of the rod elements, thereby to provide a visible indication of the number of rod elements in a learning rod formed therewith.

With this arrangement a single extrusion die can be used to make rod elements of any chosen length and cross-sectional shape, such as a tube, in any chosen colour, thereby minimising the overall cost of manufacture, and a single injection mould can be used to form the coupling elements, which may conveniently be formed is plastics of a single colour, such as white or black, the flanged region of each coupling element therefore providing a visual indication of the junction between respectively adjacent rod elements.

In accordance with a second aspect of the invention there is provided a learning rod educational toy set comprising a plurality of extruded rod elements, each rod element having an indication of its length on or in an external surface, the set including rod elements of different lengths, the rod elements being connectable end-on-end by respective coupling elements to form one or more learning rods, each of total length equal to the sum of the length of each rod element used for the or each learning rod, adjacent rod elements being connectable by respective coupling elements, each coupling element including a visual indication of the end of an extruded rod element and the junction with another such extruded rod element when joined thereto.

With this arrangement, the coupling element of each rod element effectively serves two functions, the first being to connect respective pairs of extruded rod elements and the second being to indicate by means of the flange, the end of one rod element and the beginning of another such rod element attached to it.

Conveniently, at least the flange of the moulded coupling element is of a visibly different colour to that of the rod elements such that the number of rod elements in a learning rod constructed therefrom is easily ascertainable by the user thereof. Preferably, a neutral colour such as white or black is used for the coupling elements and the rod elements are of different colours, each colour corresponding to a respectively different length and colour.

In this patent specification reference to “colour” or “visible” is intended, where the context permits, to include other means of distinguishing between rod elements of differing lengths including, without limitation, rod elements where length is indicated in Braille or by some other tactile or visual means.

### BRIEF DESCRIPTION OF THE DRAWINGS

The invention will now be described, by way of example only, with reference to the accompanying drawings in which:

FIG. 1 is a schematic view of a conventional set of Cuisenaire interlocking plastics learning rod elements of different lengths and colours,

FIG. 2 is a view of a length-indicating learning rod constructed from some of the rod elements of FIG. 1,

FIG. 3 is a perspective view of a tubular plastics extrusion for a rod element made by the method of the invention,

FIG. 4 is a perspective view of a common coupling element for connecting a rod element extrusion as shown in FIG. 3 with another such rod element, and

FIG. 5 is a perspective view of a length-indicating learning rod constructed from differently-sized rod elements and their respective coupling elements of the type shown in FIGS. 3 and 4.

### DETAILED DESCRIPTION OF THE DRAWINGS

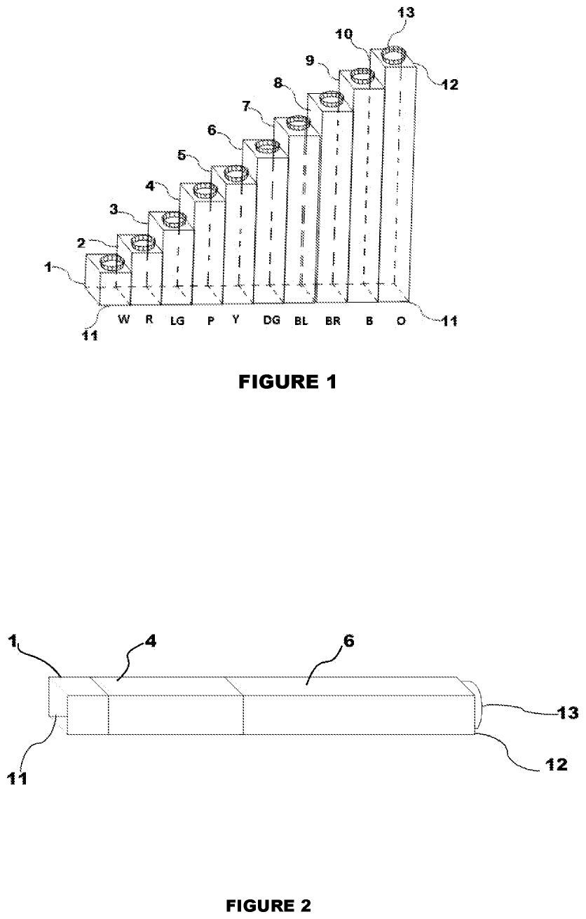

In FIG. 1 the prior art rod elements 1 to 10 are of different lengths, rod element 1 being 1 cm in length and rod element 10 being 10 cm in length. Each of these ten rod elements has its own unique colour indicated by an abbreviation: W for white, R for red, LG for light green, P for purple, Y for yellow, DG for dark green, B for black, BR for brown, BL for blue and O for Orange. Each rod element 1 to 10 comprises a hollow tube of square section having an open end 11 and a closed end 12, the closed end 12 having a cylindrical connecting pip 13 of diameter corresponding to the smallest diameter of the open end 11 such that respective pairs of rod elements 1 to 10 can be connected end-on-end in any order to form combinations of learning rods, of length corresponding to the sum of the length of each rod element in each combination rod.

FIG. 2 shows an example of a learning rod 14 constructed by connecting a white rod element 1 to a purple rod element 4 to which is then joined a dark green rod element 6, thereby making a combination learning rod having an overall length of 11 cm. As will be apparent, a student learning the basic concepts of arithmetic is therefore able to easily differentiate between rod elements of different colour and therefore of different length to other rod elements of other colours and lengths, so that the total length of any learning rod constructed can be readily determined, with a particular colour being associated with a particular length of any rod element and therefore any combination of colours enabling the student to easily calculate the overall length of each combination learning rod. Thus, where multiple sets of such rod elements 1 to 10 are available to the student, such as in a classroom context, the student can easily learn that for any given length a combination learning rod can be constructed from a variety of rod elements ranging from the fewest possible pieces, such as a two-piece combination learning rod made from a white rod element 1 connected to an orange rod element 10 to form a combination learning rod having an overall length of 11 cm, to a more complex eleven-piece rod arrangement in which eleven white rod elements 1 are connected together to form a combination rod also having an overall length of 11 cm.

The foregoing example shows the elegant simplicity of the Cuisenaire rods in conveying arithmetical concepts to students such as schoolchildren in an interesting manner which is easily understandable and tactile, requiring the selection and connection of various pieces by the student. As an improvement to this concept, each of the rod elements may be marked with an indication of its length, such as with numbers 1 to 10, so that students can quickly become familiar with the concept that numbers nearer to 10 than 1 represent rod elements that are longer than those having numbers nearer to 1. The rod elements themselves are relatively easy to manufacture if made of plastics by the process of injection moulding but an obvious disadvantage is that different moulds are required for different lengths such that a total of ten moulds are required for manufacturing the set shown in FIG. 1. In addition, the manufacturer must also provide a range of plastics in ten different colours, which also increases the overall cost.

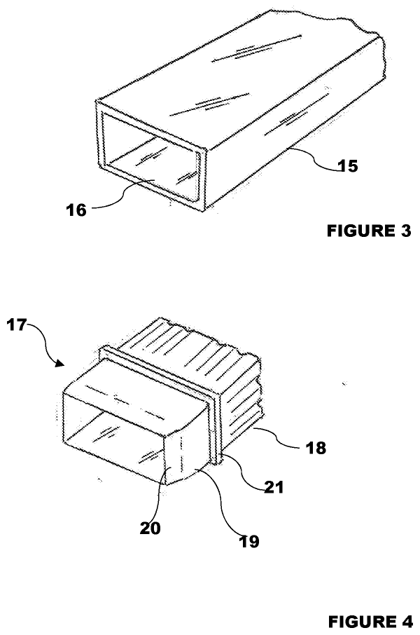

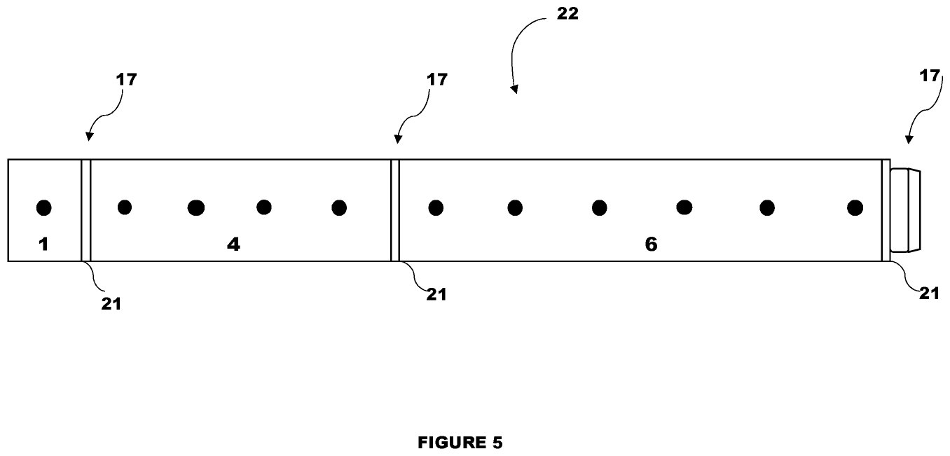

In accordance with the invention the foregoing disadvantages may be wholly or partially overcome in the manner as shown with reference to FIGS. 3 to 5. FIG. 3 shows an extruded length of plastics in the form of a hollow tube 15 of rectilinear section, although it will be appreciated that the sectional shape of the extrusion may instead be circular, square or any other required shape capable of being extruded. The open end of the extrusion 15 defines a bore 16 for receiving either end of the coupling element 17 shown in FIG. 4. The coupling element 17 includes a ribbed spigot 18 insertable within the bore 16 and retainable therein either permanently through the use of an adhesive or by microwave welding, or by means of a sufficiently tight push fit. On the opposite end of the spigot 18 is a connecting tongue or pip 19 of section generally corresponding to the bore 16 in the extrusion 15, having a tapered forward end 20 by which it may be easily insertable within a corresponding bore 16 of a cut piece of the tube 15. Between the spigot 18 and tongue 19 is a spacer flange 21 having an external perimeter of shape and size corresponding to the external perimeter of the extrusion 15 such that when respective pieces of extrusion 15 are joined together end-on-end they are able to form a contiguous rod made up of a combination of lengths of extrusion 15 in the manner as shown in FIG. 5.

In FIG. 5, there is shown a combination learning rod 22 which essentially corresponds to the combination prior art learning rod 14 shown in FIG. 2 but with the addition of the coupling elements 17 and associated spacer flanges 21, which may conveniently be of an easily identifiable common colour (such as black or white) different to that of the pieces of extrusion 15. Thus, instead of each coupling piece 17 matching the colour of the extrusion 15 to which is secured, which may be difficult to achieve if a total of ten colours are used to form the set of Cuisenaire rod elements, the present invention derives in part from the realisation that by making the coupling element 17 a distinctly different colour to the or each colour used in each extrusion 15 the flanged region 21 also provides a very convenient marker for the student to note the number and length of the elements making up the combination learning rod 22. In practice, it has been found that even where the same colour of plastics is used to form each of the extrusions 15 making up the combination learning rod 22 it is still relatively easy for the student to identify the individual elements 15 of the rod and their respective lengths.

In accordance with the method of the invention, the extrusion 15 is cut into the various lengths for forming a complete set of rod elements, such as ten of sizes between 1 cm and 10 cm in length, and each cut length is provided with a respective coupling member by inserting a spigot 18 into one of the open ends of each extrusion 15. Each cut length of extrusion 15 may conveniently be distinguished from other different lengths in the set by being of a different colour, or by having markings such as numbers or formations such as Braille lettering or any combination of such indicators whereby different lengths in the set can be distinguished.

The invention therefore provides an elegantly simple solution to the problem, otherwise, of manufacturing learning rod sets whilst using multiple moulds to produce different lengths of rod elements, and uses instead a single extrusion mould and common coupling pieces, which coupling pieces also have the advantage of providing an easily identifiable means for students to differentiate between learning rod elements of different lengths by the use of numbers or other indicia corresponding to each length of rod.

1. A method of manufacturing a learning rod educational toy set comprising a plurality of hollow rod elements, each rod element having an indication of its length on an outer surface thereof, such as by a number or a symbol indicating total length in increments, such as inches or centimetres, each rod element being releasably connectable to another such rod element by a respective coupling element, the coupling element including a flanged region having an outer perimeter contiguous with the outer perimeter of the or each rod element, the method including the steps of, in any convenient order, extruding a continuous tube or other elongate extrusion of sectional shape corresponding to the required sectional shape of the rod elements, cutting the continuous extrusion into discrete lengths corresponding to chosen increments, such as inches or centimetres, providing an indication of the length of each rod element on an externally visible surface thereof, forming flanged coupling elements, each for insertion into an end of a respective rod element extrusion for connecting selected pairs of rod elements end-on-end to form a continuous rod, the flange of each coupling element being of a colour visibly distinct from the colour of the rod elements, thereby to provide a visible indication of the number of rod elements in a learning rod formed therewith.

2. A method according to claim 1 wherein the coupling element is formed of plastics of a single colour, such as white or black and using one or more visibly different colours for the extrusions.

3. A learning rod educational toy set comprising a plurality of extruded plastic rod elements, each rod element having an indication on or in an external surface of its length, the set including rod elements of different lengths, the rod elements being connectable with each other end-on-end to form one or more learning rods of total length equal to the sum of the length of each rod element used for the or each learning rod, adjacent rod elements being connectable by respective coupling elements, each coupling element including a visual indication of the end of a rod element and the junction with another such rod element when joined thereto.

4. A learning rod toy set according to claim 3 wherein at least the flange of the coupling element is of a visibly different colour to that of the rod elements.

5. A learning rod toy set according to claim 4 wherein each coupling element is injection moulded and includes a connecting spigot with formations such as grooves, for receiving a settable adhesive, whereby to permanently join each coupling to a respective extrusion.
